(19) United States
(12) Patent Application Publication
(10) Pub. No.: US 2016/0070523 A1
(43) Pub. Date: Mar. 10, 2016

(54) DISPLAY APPARATUS, USER APPARATUS, SYSTEM AND METHOD FOR CONTROLING DISPLAY APPARATUS

(71) Applicant: SAMSUNG ELECTRONICS CO., LTD., Suwon-si (KR)

(72) Inventor: Wan Su KIM, Anyang-si (KR)

(73) Assignee: SAMSUNG ELECTRONICS CO., LTD., Suwon-si (KR)

(21) Appl. No.: 14/828,684

(22) Filed: Aug. 18, 2015

(30) Foreign Application Priority Data
Sep. 4, 2014 (KR) 10-2014-0117545

(51) Int. Cl. G06F 3/14; G09G 5/12; H04L 29/08; G06F 3/147

(52) U.S. Cl. CPC G06F 3/1454; G06F 3/147; G09G 5/12; H04L 67/24; H04L 67/306; H04L 67/025; G09G 2370/16; G09G 2380/06

(57) ABSTRACT

A display apparatus control system includes a plurality of display devices; and a user apparatus configured to generate second identification information based on first identification information of the plurality of display devices, and display the second identification information on a display of the user apparatus, wherein at least one of the plurality of display devices are configured to display the second identification information.

### CROSS-REFERENCE TO RELATED APPLICATION

This application claims priority from Korean Patent Application No. 10-2014-0117545, filed on Sep. 4, 2014, in the Korean Intellectual Property Office, the disclosure of which is incorporated herein in its entirety by reference.

### BACKGROUND

1. Field

Apparatuses and methods consistent with exemplary embodiments relate to a display apparatus and a user apparatus, a display apparatus control system, and a method for controlling the display apparatus.

2. Description of the Related Art

As technology of display devices is advanced, display devices are emerged ranging from general display devices through which images, such as a video advertisement and an information bulletin, can be easily accessed in a daily life to display devices implemented as a new type of art, such as video art.

Recently, many digital billboards have been installed at various places such as public institutions, convenience stores, banks, hospitals, roads, shopping malls, coffee shops, etc., and this trend is further spread by combining with technology of digital information display (DID) or digital signage (DS). As the DS is applied to digital media in an environment in which digital display devices, which are remotely controllable through a network, are installed at public or commercial places to provide information, entertainments, and advertisements, techniques related to a variety of information technology (IT) and content, such as content, networks, and software solutions, are complexly combined in the digital display devices in addition to a function of providing digital information of the DID.

In addition to the field of DS, demands and research for a large screen for providing content have been increased, and thus, a multi-vision screen display using a plurality of display devices is actively developed in a content display technique. In order to control the plurality of display devices, a technique for controlling each of the display devices is needed. Further, each of the display devices needs to be identified to control each of the display devices.

### SUMMARY

One or more exemplary embodiments provide a display apparatus and a user apparatus, a display apparatus control system, and a method for controlling the display apparatus.

Additional aspects of the disclosure will be set forth in part in the description which follows and, in part, will be obvious from the description, or may be learned by practice of the exemplary embodiments.

According to an aspect of an exemplary embodiment, provided is a display apparatus control system including: a plurality of display devices; and a user apparatus configured to generate second identification information based on first identification information of the plurality of display devices, and display the second identification information on a display of the user apparatus, wherein at least one of the plurality of display devices are configured to display the second identification information.

The plurality of display devices may be determined to be located within a predetermined distance from the user apparatus.

The first identification information may include at least one of an Internet protocol (IP) address, a media access control (MAC) address, and global positioning system (GPS) information.

The second identification information may include at least one of a numeral, a character, and a figure.

The plurality of display devices may be configured to display the second identification information substantially simultaneously with a display of the second identification information on the display of the user apparatus.

The user apparatus may be configured to search the plurality of display devices, and display a search list with respect to the plurality of display devices based on a search result.

The search list may include device names of the plurality of display devices.

The user apparatus may be configured to generate the second identification information with respect to display devices having the same device name among the plurality of display devices.

The user apparatus may be configured to display, on the display of the user apparatus, the same device names of the display devices together with the second identification information.

The user apparatus may be configured to generate the second identification information and, in response to setting, configured to display the second identification information on the display of the user apparatus.

The user apparatus may be configured to generate the second identification information and, in response to a presence of display devices having the same device name among the plurality of display devices, configured to display the second identification information on the display of the user apparatus.

According to an aspect of an exemplary embodiment, provided is a user apparatus for controlling a plurality of display devices, the user apparatus including: a terminal display; and a terminal controller configured to generate second identification information based on first identification information of the plurality of display devices, wherein the terminal controller is configured to control the terminal display to display the second identification information.

The plurality of display devices may be determined to be located within a predetermined distance from the user apparatus.

The first identification information may include at least one of an IP address, a MAC address, and GPS information.

The second identification information may include at least one of a numeral, a character and a figure.

The terminal controller may be configured to control the terminal display to display a search list with respect to the plurality of display devices based on a search result.

The search list may include device names of the plurality of display devices.

The terminal controller may be configured to generate the second identification information with respect to display devices having the same device name among the plurality of display devices.

The terminal controller may be configured to control the terminal display to display the device names together with the second identification information.

The terminal controller may be configured to generate the second identification information and, in response to setting, configured to control the terminal display to display the second identification information.

The terminal controller may be configured to control the terminal to display the second identification information in response to setting.

The terminal controller may be configured to generate the second identification information in response to a presence of display devices having the same device name among the plurality of display devices.

The terminal controller may be configured to control the terminal display to display the second identification information in response to a presence of display devices having the same device name among the plurality of display devices.

According to an aspect of an exemplary embodiment, provided is a display apparatus controlled by a user apparatus, the display apparatus including: a storage configured to store first identification information of the display apparatus; a communicator configured to receive second identification information, the second identification being generated by the user apparatus based on the first identification information; and a display configured to display the second identification information.

The display apparatus may be determined to be located within a predetermined distance from the user apparatus.

The first identification information may include at least one of an IP address, a MAC address, and GPS information.

The second identification information may include at least one of a numeral, a character, and a figure.

The display may be configured to display the second identification information substantially simultaneously with a display of the second identification information on a display of the user apparatus.

According to an aspect of an exemplary embodiment, provided is a method of controlling a display apparatus, the method including: generating, by a user apparatus, second identification information based on first identification information of a plurality of display devices, the user apparatus controlling the plurality of display devices; displaying the second identification information on a display of the user apparatus; transmitting the second identification information to the plurality of display devices from the user apparatus; and displaying the second identification information on at least one of the plurality of display devices.

According to an aspect of an exemplary embodiment, provided is an apparatus for controlling a plurality of display apparatuses, the apparatus including: a display configured to display a list of the plurality of display apparatuses and first identification information corresponding to the respective plurality of display apparatuses; a user interface configured to receive a user input; and a controller configured to, in response to the user input, control the display to display the list of the plurality of display apparatuses and second identification information, different from the first identification information, corresponding to the respective plurality of display apparatuses.

The controller may be configured to generate the second identification information based on model names of the plurality of display apparatuses.

### BRIEF DESCRIPTION OF THE DRAWINGS

The above and/or other aspects will become more apparent by describing certain exemplary embodiments with reference to the accompanying drawings in which:

FIG. 1 is a schematic view illustrating a display apparatus control system according to an exemplary embodiment;

FIG. 2 is a schematic view illustrating a display apparatus control system according to another exemplary embodiment;

FIG. 3 is a block diagram of a display apparatus control system according to an exemplary embodiment;

FIG. 4 is a front view illustrating a display apparatus according to an exemplary embodiment;

FIG. 5 is an example view of a display apparatus provided as a large display;

FIGS. 6 and 7 are front views illustrating display apparatuses according to other exemplary embodiments;

FIG. 8 is a perspective view illustrating a display apparatus according to still another exemplary embodiment;

FIGS. 9A and 9B are views of a display apparatus according to other exemplary embodiments;

FIG. 10 is a view for describing a search list of a display apparatus searched through a user device according to an exemplary embodiment;

FIG. 11 is a view illustrating an example of displaying second identification information;

FIG. 12 is a view illustrating another example of displaying second identification information;

FIG. 13 is a view illustrating still another example of displaying second identification information;

FIG. 14 is a view illustrating yet another example of displaying second identification information;

FIG. 15 is a view illustrating yet another example of displaying second identification information;

FIG. 16 is a view illustrating yet another example of displaying second identification information;

FIG. 17 is a view illustrating yet another example of displaying second identification information;

FIG. 18 is a view illustrating yet another example of displaying second identification information;

FIG. 19 is a view illustrating yet another example of displaying second identification information;

FIG. 20 is a view illustrating yet another example of displaying second identification information;

FIG. 21 is a flowchart illustrating a display apparatus control method according to an exemplary embodiment; and

FIG. 22 is a flowchart illustrating a display apparatus control method according to another exemplary embodiment.

### DETAILED DESCRIPTION

Certain exemplary embodiments are described in greater detail below with reference to the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. Sizes of elements in the drawings may be exaggerated for convenience of explanation. In other words, since sizes and thicknesses of components in the drawings are arbitrarily illustrated for convenience of explanation, the following exemplary embodiments are not limited thereto.

Hereinafter, a display apparatus and a user device, a display apparatus control system, and a method for controlling the display apparatus will be described in detail with reference to accompanying drawings according to the exemplary embodiments described below.

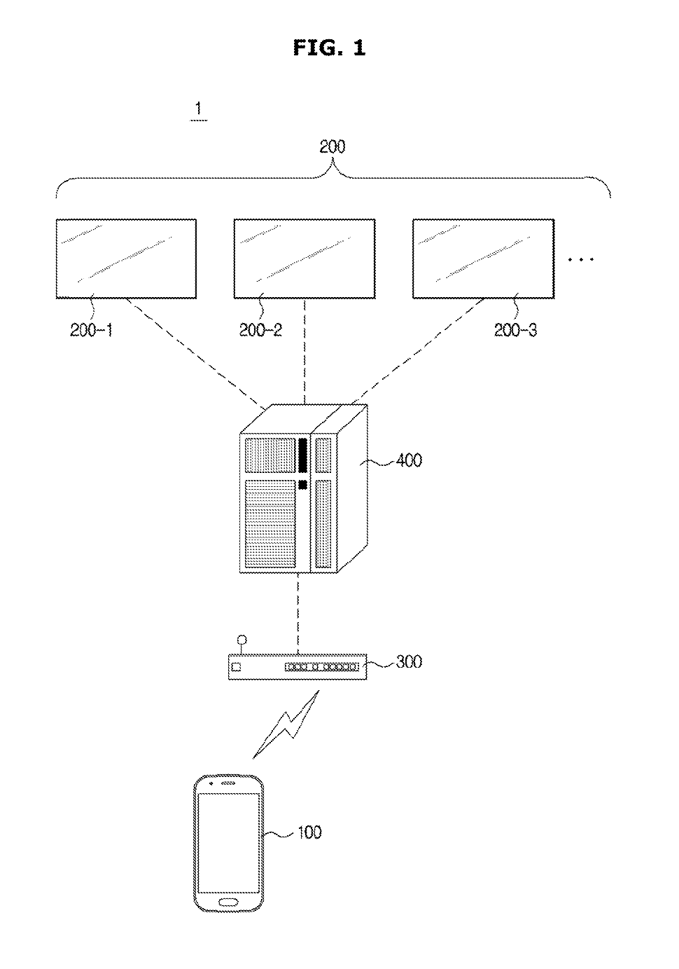

FIG. 1 is a schematic view illustrating a display apparatus control system according to an exemplary embodiment.

Referring to FIG. 1, a display apparatus control system 1 may include a display apparatus 200, a server 400, an access point (AP) 300, and a user device 100, and the display apparatus 200, the server 400, the AP 300, and the user device 100 may be connected through a wired and/or wireless network.

The display apparatus 200 is a display apparatus providing various types of content, and installed in a hospital, a public institution, a private institution, a coffee shop, a subway, or any other various places so that a specific or arbitrary viewer may watch content provided thereon. Here, the content may include texts, photographs, static images, moving images, etc.

The display apparatus 200 may be implemented in a plurality of display devices. Although an example of the display apparatus 200 is implemented in a display device 200-1, a display device 200-2, and a display device 200-3 in FIG. 1, the display apparatus 200 may be implemented in more or less number of the display devices. The display apparatus 200 will be described later in detail.

The server 400 is connected to the user device 100 and the display apparatus 200 through a wired network. The server 400 generates, manages or stores content, and transmits the content to the display apparatus 200 to be displayed. The server 400 may receive a user command from the user device 100 for displaying content.

The server 400 may generate or receive the content to be displayed on the display apparatus 200. The server 400 may generate content and/or receive content generated by an external device or system. Further, the server 400 may receive content from the user device 100. The server 400 may convert the content generated or received by the server 400 to a format suitable for displaying on the display apparatus 200.

The server 400 may manage or schedule the content to be displayed in proper timing. When various types of content need to be sequentially displayed, the server 400 may schedule a display date, a display time, a display order, and so on with respect to the various types of content. The server 400 may perform a process which divides or resizes the content according to the number of the display devices included in the display apparatus 200 connected thereto, or distribute the content. The display apparatus 200 may receive and display the content that is processed or distributed corresponding to the display apparatus 200.

The server 400 may store the content generated or received by the server 400, and store the processed or distributed content. Further, the server 400 may store information for managing the content or scheduling information of the content.

The server 400 may set or receive first identification information capable of identifying the display apparatus 200. Here, the first identification information may include at least one of an internet protocol (IP) address, a media access control (MAC) address, and global positioning system (GPS) information, but it is not limited thereto, and arbitrarily different type identification information that is well-known in the art may be provided.

When the first identification information is provided with an IP address, a MAC address, etc., the server 400 may set the first identification information for the display apparatus 200 and store the set first identification information according to the number of display apparatuses. Here, the server 400 may store a device name of the display apparatus 200 together with the set first identification information thereof. The first identification information may not be set through the server 400. The first identification information may be preset for the display apparatus 200, and in this case, the server 400 may receive a device name and location information of the display apparatus 200.

When the first identification information is provided as a type of GPS information, the server 400 may receive the first identification information of the display apparatus 200 and store location information of the received first identification information. Here, the server 400 may store a device name of the display apparatus 200 together with the received first identification information thereof. The server 400 may not directly receive the first identification information of the display apparatus 200, but an external device or the display apparatus 200 may receive the first identification information to transmit to the server 400. Similarly, the server 400 may receive a device name of a corresponding display device included in the display apparatus 200 when the first identification information is received.

As described above, the server 400 may set or receive the first identification information of the display apparatus 200, or receive the first identification information which is preset to the display apparatus 200 or received by an external device or the display apparatus 200. Hereinafter, for the convenience of description, it will be described with an assumption that the first identification information is preset to the display apparatus 200 and the server 400 receives the preset first identification information, or the display apparatus 200 receives the first identification information to transmit to the server 400 and the server 400 receives the first identification information transmitted from the display apparatus 200.

Further, the server 400 may be a server to provide a digital information display (DID) or digital signage (DS). When the DID or DS may be provided, the exemplary embodiments are not limited to the above-described examples and may also perform another function.

The AP 300 provides a network, such as a wireless-fidelity (Wi-Fi) or Bluetooth network, for communication with the user device 100. The AP 300 serves as a gateway between the user device 100 and the server 400, and may transmit or receive a signal, information, or data between the user device 100 and server 400. The AP 300 may have a routing function or security function.

The user device 100 may be a movable device carried by a user, and includes a widely used device such as a smartphone, a tablet PC, or the like in which various applications may be installed and driven according to computing functions. Here, the user may include a viewer who watches content provided by the display apparatus 200 in a hospital, a public institution, a private institution, a coffee shop, a subway, or one of other various places, a manager who manages the display apparatus 200, an operator who operates the display apparatus 200, etc.

At least one application may be installed in the user device 100 to operate the display apparatus 200. The user device 100 may be connected to the AP 300 or the server 400 through a network, and may operate the display apparatus 200. In an exemplary embodiment, the user device 100 may also be connected to the AP 300 or the server 400 through a wireless personal area network (WPAN).

The user device 100 provides various types of information or receives a user command so that a user may operate the display apparatus 200. The user device 100 provides various types of information or receives a user command so that the content may be displayed through the display apparatus 200. When the display apparatus 200 is provided in a plurality of display apparatuses, the user device 100 may provide second identification information capable of intuitively identifying each of the display apparatuses 200. Further, the user device 100 may receive a select command to select and operate a specific display apparatus 200. The second identification information and the user device 100 will be described later in more detail.

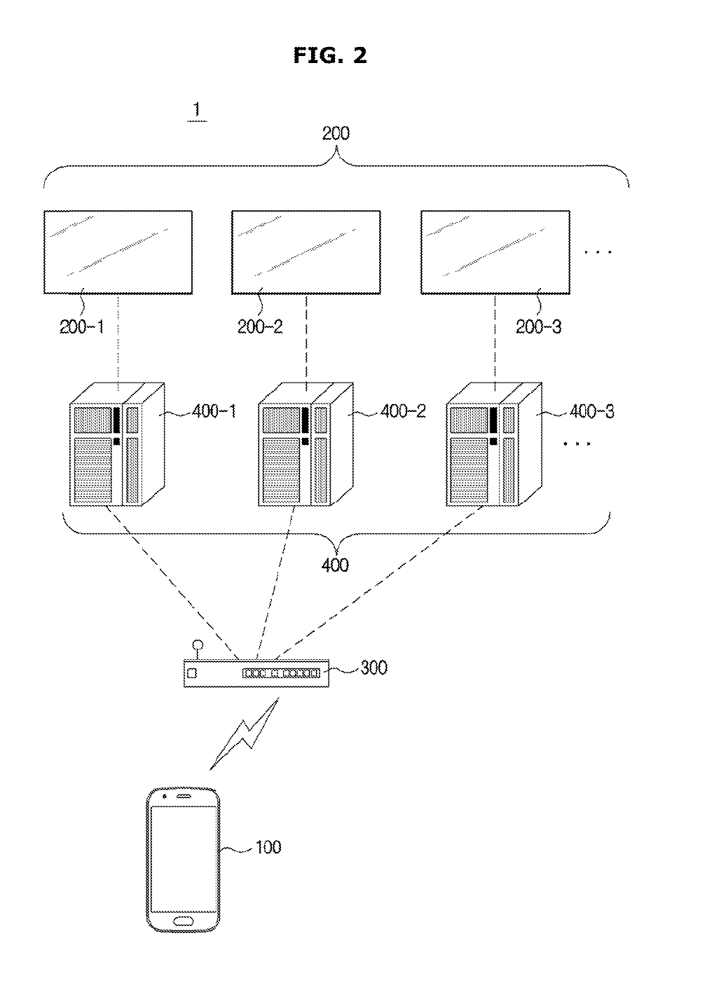

FIG. 2 is a schematic view illustrating a display apparatus control system according to another exemplary embodiment. For the convenience of description, elements having configurations and functions the same as or similar to those of the above-described elements are used using the same drawing numerals as those of the above-described embodiment, and duplicate descriptions are omitted.

Referring to FIG. 2, a display apparatus control system 1 may include a display apparatus 200, a server 400, an AP 300, and a user device 100, and the display apparatus 200, the server 400, the AP 300, and the user device 100 may be connected through a wired and/or wireless network.

The display apparatus 200 may be implemented in a plurality of display devices. The server 400 may not be provided as one central server connected to the plurality of display devices, but may be provided in a plurality of servers according to each of the display devices 200-1, 200-2, and 200-3 included in the display apparatus 200 as shown in FIG. 2. Servers 400-1, 400-2, and 400-3 included in the server 400 are individually connected to the user device 100 and the respective display devices 200-1, 200-2, and 200-3 included in the display apparatus 200 through a wired and/or wireless network.

For example, the server 400-1 is provided for the display device 200-1, and the server 400-1 connects the display device 200-1 to the user device 100 through a network and the AP 300. Further, the server 400-2 is provided for the display device 200-2, and the server 400-2 connects the display device 200-2 to the user device 100 through the network and AP 300. Similarly, the server 200-3 is provided for the display device 200-3, and the server 400-3 connects the display device 200-3 to the user device 100 through the network and AP 300.

Each of the servers 400-1, 400-2, and 400-3 included in the server 400 may serve to generate, manage, and store content, and serve to set, receive, and store the first identification information of the display apparatus 200. Duplicate descriptions of the server 400 are omitted.

The display apparatus control system 1 includes the AP 300 similar to the exemplary embodiments described with reference to FIGS. 1 and 2. However, in an alternative embodiment, the AP 300 may not be included in the display apparatus control system 1 or may be omitted according to a type of a network or a communication method. Further, the display apparatus control system 1 includes the server 400, that is, one server or a plurality of servers, according to the above-described exemplary embodiments. However, in an alternative embodiment, the server 400 may not be included or may be omitted according to a type of the display apparatus 200, a type or format of content, etc. Hereinafter, for the convenience of description, it will be described on an assumption that the display apparatus control system 1 includes the server 400.

As described above, the components of the display apparatus control system 1 is schematically described. Hereinafter, the components of the display apparatus control system 1 capable of identifying display devices and the function of each component will be described with reference to a block diagram of the display apparatus control system 1 in more detail.

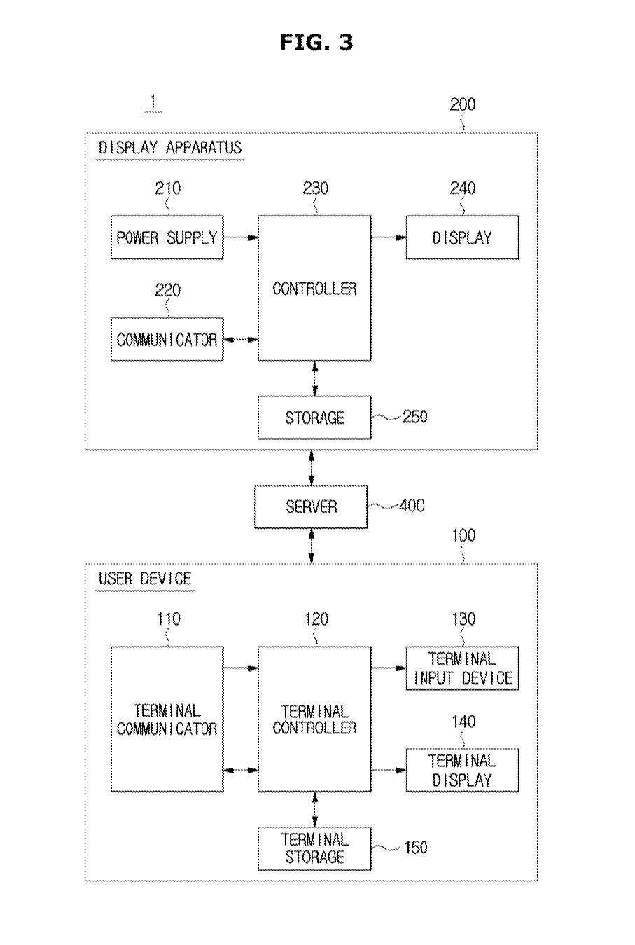

FIG. 3 is a block diagram of a display apparatus control system according to an exemplary embodiment.

Referring to FIG. 3, the display apparatus control system 1 may include a server 400, and a display apparatus 200 and a user device 100 which are connected through the server 400. The display apparatus 200 may include a power supply 210, a communicator 220, a controller 230, a display 240, and a storage 250, and the user device 100 may include a terminal communicator 110, a terminal controller 120, a terminal input device 130, a terminal display 140, and a terminal storage 150.

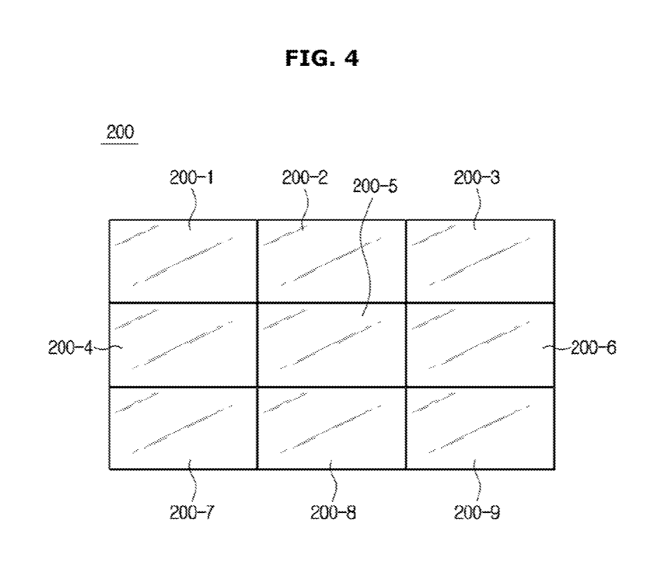

FIG. 4 is a front view illustrating a display apparatus according to an exemplary embodiment.

Referring to FIG. 4, a display apparatus 200 may include a plurality of display devices 200-1, 200-2, 200-3, 200-4, 200-5, 200-6, 200-7, 200-8, and 200-9. Each of the plurality of display devices 200-1 to 200-9 may be provided in a quadrilateral shape as shown in FIG. 4, but the exemplary embodiments are not limited thereto and may be provided in an arbitrarily different shape instead of the quadrilateral shape. The plurality of display devices 200-1 to 200-9 may be provided in the same shape, or at least one of the plurality of display devices 200-1 to 200-9 may be provided in a different shape. Hereinafter, for the convenience of description, it is assumed that the plurality of display devices 200-1 to 200-9 provided in the quadrilateral shape.

The plurality of display devices 200-1 to 200-9 may be provided to have the same size, or at least one of the plurality of display devices 200-1 to 200-9 may be provided to have a different size. Further, the plurality of display devices 200-1 to 200-9 may have the same device name or model name, or at least one of the plurality of display devices 200-1 to 200-9 may have a different device name or model name.

The plurality of display devices 200-1 to 200-9 may be combined to form the display apparatus 200 in an overall quadrilateral shape. In an exemplary embodiment, as shown in FIG. 4, the plurality of display devices 200-1 to 200-9 may sequentially form a first row, a second row, and a third row, and each row may include the same number of the display devices. In other words, the display devices 200-1, 200-2, and 200-3 may form the first row, the display devices 200-4, 200-5 and 200-6 may form the second row, and the display devices 200-7, 200-8 and 200-9 may form the third row.

The front surface of each of the plurality of display devices 200-1 to 200-9 may form the display 240 which displays content, and a combination of the plurality of display devices may provide a large display.

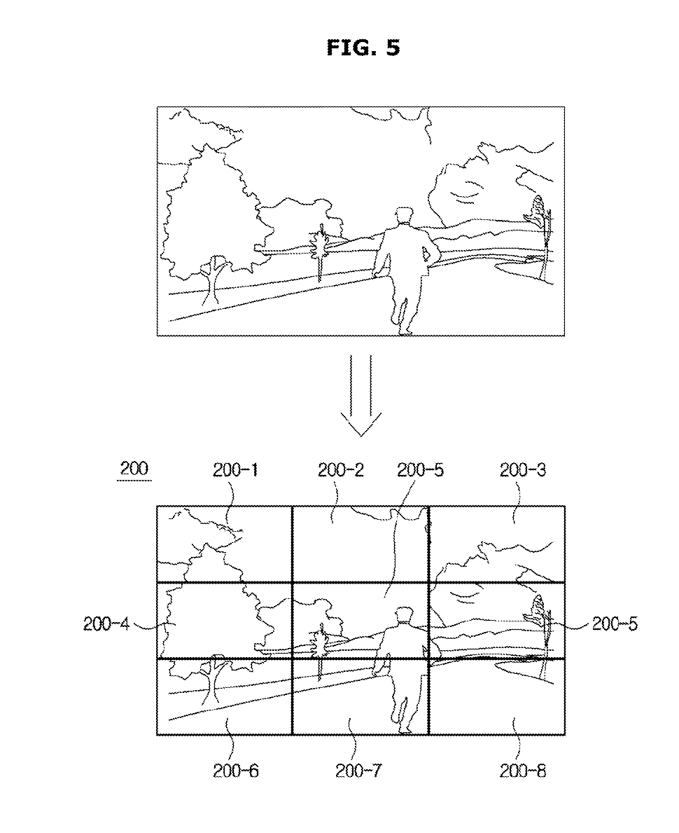

FIG. 5 is an example view of a display apparatus provided as a large display.

Referring to FIG. 5, content shown in an upper view of FIG. 5 may be suitably divided according to locations and the number of the plurality of display devices 200-1 to 200-9 through the server 400. The content may be divided according to a size and a shape of a corresponding display device, and a process of resizing the divided content may be performed to match the divided content with the size and the shape of the corresponding display device. The content may be subject to another image processing process in addition to the process of dividing and resizing the divided content. The image-processed content may be distributed to a location of each of the display devices 200-1 to 200-9, and each of the display devices 200-1 to 200-9 may display the distributed content. Accordingly, as shown in FIG. 5, a single piece of content may be visually provided through the plurality of display devices 200-1 to 200-9.

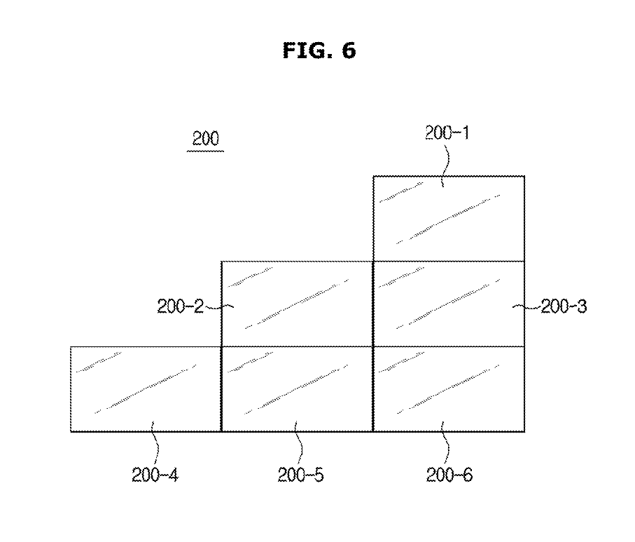

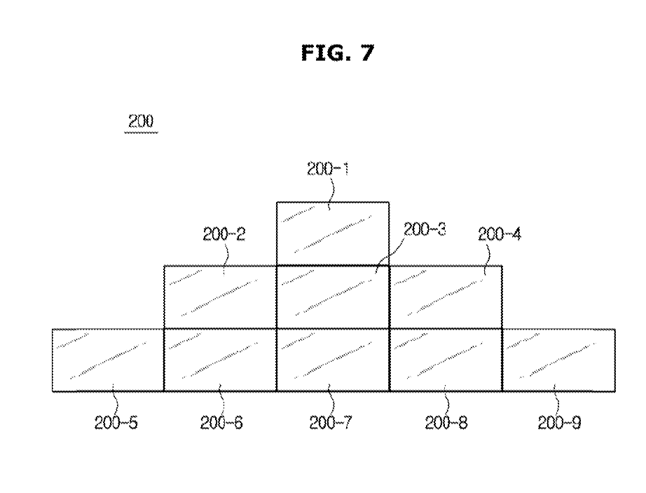

FIGS. 6 and 7 are front views illustrating display apparatuses according to other exemplary embodiments.

Referring to FIG. 6, a display apparatus 200 includes a plurality of display devices 200-1, 200-2, 200-3, 200-4, 200-5, and 200-6, and the display apparatus 200 may be provided as a large display in an overall step shape by arranging the plurality of display devices 200-1 to 200-6. The display device 200-1 of the plurality of display devices 200-1 to 200-6 may form a first row, the display devices 200-2 and 200-3 may form a second row, and the display devices 200-4, 200-5 and 200-6 may form a third row.

Referring to FIG. 7, a display apparatus 200 includes a plurality of display devices 200-1 to 200-9, and the display apparatus 200 may be provided as a large display having a step shape in bidirectional manner by arranging the plurality of display devices 200-1 to 200-9. The display device 200-1 of the plurality of display devices 200-1 to 200-9 may form a first row, the display devices 200-2, 200-3 and 200-4 may form a second row, and the display devices 200-5, 200-6, 200-7, 200-8 and 200-9 may form a third row.

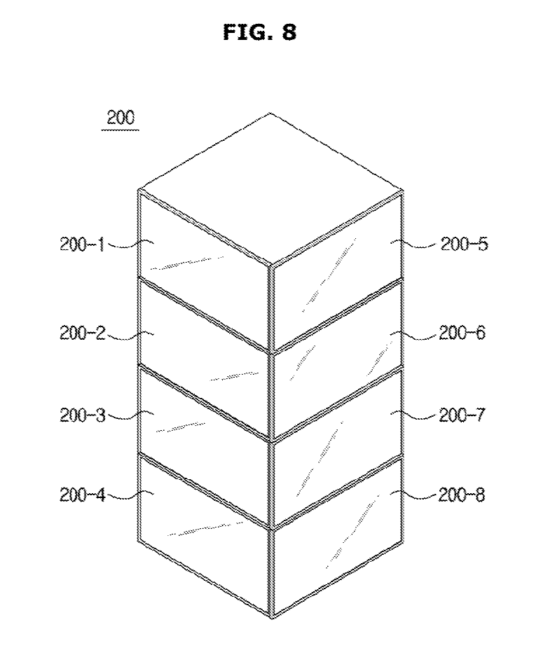

FIG. 8 is a perspective view illustrating a display apparatus according to still another exemplary embodiment.

Referring to FIG. 8, a display apparatus 200 includes a plurality of display devices 200-1, 200-2, 200-3, 200-4, 200-5, 200-6, 200-7, and 200-8, and the display apparatus 200 may be provided as a large display viewable from multiple angles by arranging the plurality of display devices 200-1 to 200-8. The plurality of display devices 200-1 to 200-8 may sequentially form a first column and a second column on different planes, and the same number of display devices may be provided in first and second columns. For example, the display devices 200-1, 200-2, 200-3 and 200-4 may form the first column, and the display devices 200-5, 200-6, 200-7 and 200-8 may form the second column.

The display devices 200-1, 200-2, 200-3 and 200-4 in the first column may have form an angle from a plane on which the display devices 200-5, 200-6, 200-7 and 200-8 in the second column are provided. A single piece of content may be displayed through the display devices 200-1, 200-2, 200-3 and 200-4 in the first column and the display devices 200-5, 200-6, 200-7 and 200-8 in the second column, or content displayed through the display devices 200-1, 200-2, 200-3 and 200-4 in the first column may be different from content displayed through the display devices 200-5, 200-6, 200-7 and 200-8 in the second column.

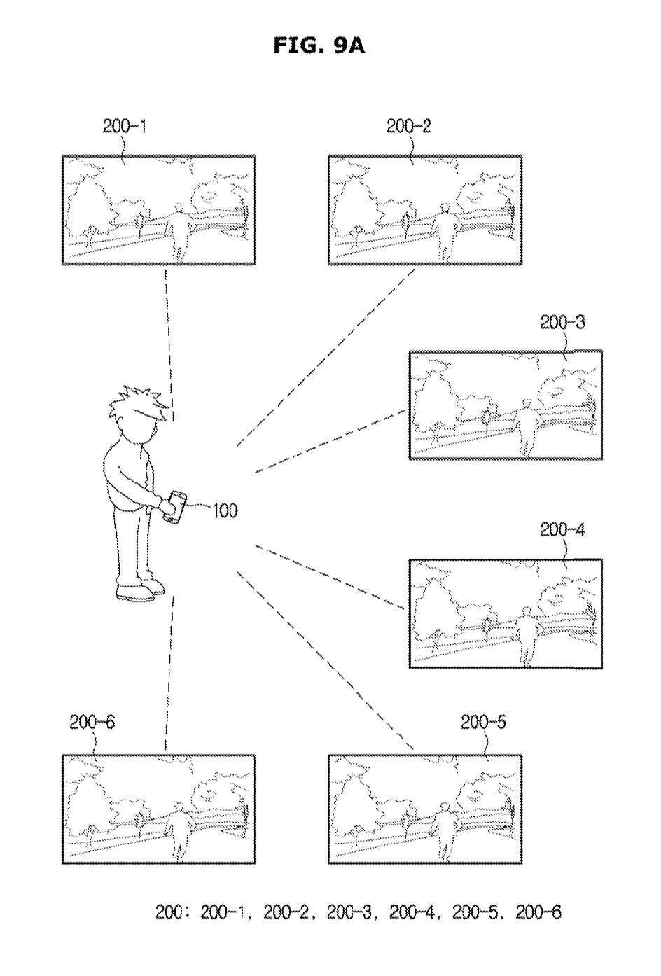

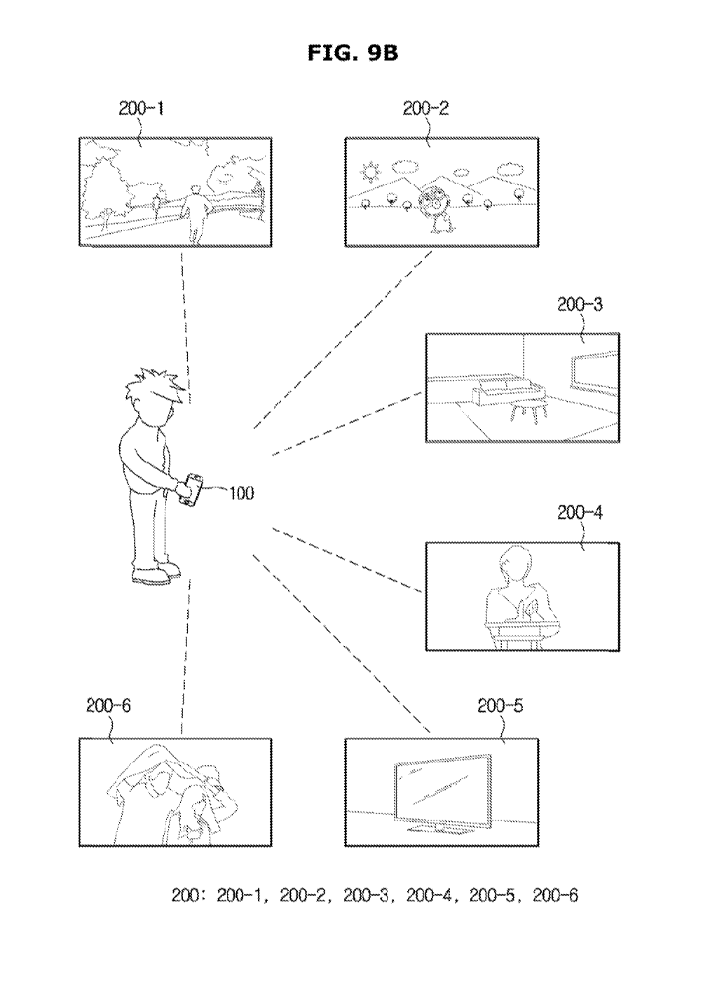

FIGS. 9A and 9B are views of a display apparatus according to other exemplary embodiments.

Referring to FIG. 9A, a display apparatus 200 may include a plurality of display devices 200-1, 200-2, 200-3, 200-4, 200-5, and 200-6 provided within a predetermined distance based on a user device 100. Here, the plurality of display devices 200-1, 200-2, 200-3, 200-4, 200-5, and 200-6 are not provided to be arranged in a certain shape, but may be provided independently from each other.

The plurality of display devices 200-1 to 200-6 may be independently provided in one space, or at least one of the plurality of display devices 200-1 to 200-6 may be provided in a separate space. All of the plurality of display devices 200-1 to 200-6 may be provided in different spaces from each other.

Content is provided as a single piece of content, and may be identically transmitted to the plurality of display devices 200-1 to 200-6. Thus, the plurality of display devices 200-1 to 200-6 may display the same content.

The content may be provided as plural pieces of content. For example, the content may be provided in the plural according to the number of display devices 200-1 to 200-6 included in the display apparatus 200. Accordingly, different contents may be distributed to the plurality of display devices 200-1 to 200-6, and the plurality of display devices 200-1 to 200-6 may display contents different from each other as shown in FIG. 9B.

The configuration and shape of the display apparatus 200 have been described with reference to FIGS. 4 to 9B, but those are not limited thereto and the display apparatus 200 may also be provided as a different configuration or different shape. Hereinafter, for the convenience of description, it will be described on an assumption that display apparatus 200 is a combination of the plurality of display devices and is provided as a large display in a quadrilateral shape.

Referring again to FIG. 3, each of the plurality of display devices 200 included in the display apparatus 200 may include a power supply 210, a communicator 220, a controller 230, a display 240, and a storage 250.

The power supply 210 may receive an external or internal power source to supply the power source to the display apparatus 200 to be operated. The power supply 210 may supply the power source to the communicator 220, the controller 230, the display 240, and the storage 250 which are components of the display apparatus 200.

The power supply 210 may be implemented as a primary battery, such as a mercury battery, a manganese battery, an alkaline battery, a lithium battery, etc., or a secondary battery such as a Ni—Cd battery, a Ni—NH battery, a lead-acid battery, a lithium-ion battery, a lithium-polymer battery, etc. Further, the power supply 210 may be implemented as a solar cell battery, which generates electrical power using solar power, and is not limited to the type thereof. When an external power source is applied to the power supply 210, a user may charge the power supply 210 by connecting the display device apparatus 200 to the external power source using a wire.

The communicator 220 connects the display apparatus 200 to an external device using various communication methods, and transmits and/or receives a signal or information to and/or from the external device.

As described above, first identification information is preset to the display apparatus 200, or the display apparatus 200 may receive the first identification information. When the display apparatus 200 receives the first identification information, the communicator 220 is connected to the external device using wired or wireless communication to receive the first identification information of a corresponding display apparatus 200 from the external device.

The communicator 220 may be connected to the server 400 using wired or wireless communication to transmit the first identification information of the display apparatus 200 to the server 400. When the first identification information is transmitted, the communicator 220 may transmit the first identification information together with a device name or model name of the display apparatus 200.

Further, the communicator 220 may receive various types of user commands through the server 400, and receive second identification information or content from the server 400. Here, the second identification information is information for intuitively identifying display devices when the display apparatus 200 is implemented in the plurality of display devices, generated based on the first identification information, and provided with numerals, characters, figures, or a combination thereof. The second identification information is not limited to the above, and may be provided with different formats as long as the plurality of display devices included in the display apparatus 200 may be intuitively identified by the second identification information.

To this end, the communicator 220 may include various communication modules such as a wireless Internet module, a short-range communication module, a GPS module, etc.

The wireless Internet module refers to a module connected to an external network according to a communication protocol, such as a wireless local area network (WLAN), Wi-Fi, wireless broadband (Wibro), world interoperability for microwave access (WiMAX), high speed downlink packet access (HSDPA), etc., to perform communication.

The short-range communication module refers to a module in communication with an external device located in a short range according to a short-range communication method such as Bluetooth, radio frequency identification (RFID), infrared data association (IrDA) communication, ultra wideband (UWB), ZigBee, etc.

The GPS module refers to a module for receiving GPS signals or navigation messages from satellites to detect a location of the display apparatus 200 (e.g., a latitude coordinate, a longitude coordinate, etc.).

The display 240 displays the second identification information transmitted through the server 400. The second identification information may be simultaneously displayed to the user device 100 and the display 240. A user may identify each of the plurality of display devices included in the display apparatus 200 based on the displayed second identification information, and select a display device to be operated among the plurality of display devices included in the display apparatus 200. The detailed description will be described below.

The display 240 displays content transmitted from the server 400. The display 240 may display content distributed to a corresponding display device among the plurality of display devices included in the display apparatus 200.

The display 240 may include a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, an organic light emitting diode (OLED) panel, or the like, but is not limited thereto.

The controller 230 controls overall operations of the display apparatus 200. The controller 230 may generate control signals to control each component of the display apparatus 200, i.e., the communicator 220, the display 240, the storage 250, etc.

The controller 230 may generate a control signal based on a user command transmitted through the server 400. For example, when a user inputs a set command for displaying second identification information to the user device 100, the server 400 transmits the set command to the display apparatus 200, and the controller 230 may generate a control signal to display the second identification information on the display 240 based on the transmitted set command. Further, when the user inputs a user command to display content to the user device 100, the server 400 distributes or transmits the content to the display apparatus 200 based on the user command, and the controller 230 may generate a control signal to display the distributed or transmitted content.

The controller 230 may be one of various types of processors including at least one chip in which an integrated circuit is provided. The controller 230 may be provided with one processor, and also provided with a plurality of separate processors. The controller 230 may be implemented as a processor or a controller, such as a central processor unit (CPU), a micro controller unit (MCU), or a micro processor unit (MPU).

The storage 250 temporarily or permanently stores data and a program for operating the display apparatus 200. For example, the storage 250 may store a device name, first identification information of the corresponding display apparatus 200, and second identification information transmitted through the server 400. Further, the storage 250 may store content transmitted from the server 400. The storage 250 may store a program for displaying the second identification information, a program for displaying the content, etc. The storage unit 250 may include at least one of an integrated circuit (IC) memory (for example, a read only memory (ROM), a random access memory (RAM), or a flash memory), a magnetic memory (for example, a hard disk or a diskette drive), and an optical memory (for example, an optical disk).

The storage 250 may include at least one type of storage media such as a flash memory type, a hard disk type, a multimedia card micro type, a card type memory (e.g., a secure digital (SD) memory, an extreme digital (XD) memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, etc. The storage 250 is not limited to the above, and may be implemented as an arbitrarily different form well-known in the art. Further, the display apparatus 200 may manage a web storage which performs a storage function on the Internet.

The user device 100 may include a terminal communicator 110, a terminal controller 120, a terminal input device 130, a terminal display 140, and a terminal storage 150.

The terminal communicator 110 connects the user device 100 to an external device according to one of various communication methods to transmit and/or receive a signal and/or information to or from the external device.

The terminal communicator 110 is connected to the server 400 using wired and/or wireless communication to receive a device name and first identification information of the display apparatus 200 from the server 400. The terminal communicator 110 receives a device name and first identification information of each of the plurality of the display devices included in the display apparatus 200.

The terminal communicator 110 transmits second identification information for identifying the display devices to the display apparatus 200 through the server 400. The terminal communicator 110 may transmit content to the server 400. The terminal communicator 110 may receive content from a broadcast station, a mobile communication base station, an external server, or the like in real time and transmit the content to the server 400, and transmit content temporarily or permanently stored in the terminal storage 150 to the server 400.

The terminal communicator 110 may transmit a user command input through the terminal input device 130 or the terminal display 140 to the server 400.

To this end, the terminal communicator 110 may include various communication modules. For example, the terminal communicator 110 may include a broadcast receiving module, a mobile communication module, a wireless Internet module, a short-range communication module, etc.

The broadcast receiving module may include a terrestrial broadcast receiving module which includes an antenna, a demodulator, an equalizer, and so on to receive a terrestrial broadcast signal, a digital multimedia broadcasting (DMB) module which receives and processes DMB signals, etc. The mobile communication module refers to a module connected to a mobile communication network according to one of various mobile communication standards, such as 3rd generation (3G), 3rd generation partnership project (3GPP), long term evolution (LTE), etc., to perform communication. The wireless Internet module and short-range communication module are the same as those described in the communicator 220.

The terminal input device 130 may input various types of user commands to operate the display apparatus 200. For example, a user may input a search command for searching the display apparatus 200 located near the user device 100, a set command for displaying second identification information of the display devices included in the searched display apparatus 200, a select command for selecting a display device to be operated from the display apparatus 200, a display command for displaying content on the display apparatus 200, and so on through the terminal input device 130.

The terminal input device 130 may include hardware input devices, such as various types of buttons or switches, a pedal, a keyboard, a mouse, a track-ball, various types of levers, a handle or stick, etc., for inputting by a user. The terminal input device 130 may include software input devices, i.e., a graphical user interface (GUI), such as a touch pad, etc., for inputting by a user. The touch pad is implemented as a touch screen panel (TSP) to form a mutual layer structure with the terminal display 140.

The terminal display 140 may display various types of information to operate the display apparatus 200. For example, the terminal display 140 may display a search list of the display apparatus 200 located near the user device 100. Here, device names of the display devices included in the display apparatus 200 transmitted through the server 400 may be included in the search list. The terminal display 140 may display second identification information of the searched display apparatus 200. The terminal display 140 may display the device names together with the second identification information in the search list.

The terminal display 140 may display a set screen. The set screen may include a menu which may set whether the second identification information is displayed. That is, a user may, from the menu, select a menu item to set second identification information to be displayed, or select to set the second identification information not to be displayed. The terminal display 140 may display second identification information of the searched display apparatus 200 according to selection of the menu item by the user on the menu.

When some display devices included in the searched display apparatus 200 have the same device names, the terminal display 140 may display second identification information thereof. When the same device names are in the search list, the terminal display 140 may display the device names together with the second identification information thereof to identify the display devices included in the searched display apparatus 200. The terminal display 140 may display the second identification information with respect to the some display devices (e.g., display devices having the same device name), or the second identification information with respect to all of the display devices included in the searched display apparatus 200.

The terminal display 140 may include a CRT, a DLP panel, a plasma display penal, an LCD panel, an EL panel, an EPD panel, an ECD panel, an LED panel, an OLED panel, etc., but is not limited thereto.

As described above, when the terminal display 140 is provided with a TSP forming a mutual layer structure with a touch pad, the terminal display 140 may serve as an input device in addition to a display device.

The terminal controller 120 controls overall operations of the user device 100. The terminal controller 120 may control each component of the user device 100, i.e., the terminal communicator 110, the terminal display 140, the terminal storage 150, etc. The terminal controller 120 may be implemented as a processor or a controller, such as a central processor unit (CPU), a micro controller unit (MCU), or a micro processor unit (MPU). The terminal storage 250 may include at least one of an integrated circuit (IC) memory (for example, a read only memory (ROM), a random access memory (RAM), or a flash memory), a magnetic memory (for example, a hard disk or a diskette drive), and an optical memory (for example, an optical disk).

Particularly, the terminal controller 120 may generate second identification information based on a device name and first identification information of the display apparatus 200. The terminal controller 120 may generate second identification information with respect to display devices included in the display apparatus 200 when the names of the display devices are identical, and here, the second identification information may be generated to have a corresponding relationship with the first identification information. In other words, the terminal controller 120 may generate different second identification information with respect to different display devices from each other or display devices having different first identification information. Further, the terminal controller 120 generates the second identification information having a format which may be intuitively recognized by a user according to the first identification information.

The terminal controller 120 may generate second identification information with respect to all of the display devices included in the searched display apparatus 200, or may generate the second identification information with respect to only some display devices, e.g., display devices having the same device name. The terminal controller 120 may generate the second identification information having the same format, or may generate the second identification information having different formats. For example, second identification information having a numeral format may be generated with respect to some display devices, and second identification information having a character format may be generated with respect to other display devices.

A user may select a menu item for displaying second identification information in a set screen, and the terminal controller 120 may generate the second identification information based on setting by the user.

The terminal controller 120 may generate a control signal to display the generated second identification information of a display device included in the searched display apparatus 200, and the terminal display 140 displays the second identification information based on a control signal of the terminal controller 120. The terminal controller 120 may generate the control signal to automatically display the second identification information after a search list is displayed, or to display the search list together with the second identification information.

A user may select a menu item for displaying the second identification information in a set screen, and the terminal controller 120 may control to display the second identification information based on setting by the user.

When the same device names are in the search list, the terminal controller 120 may control the terminal display 140 to display the second identification information. The terminal controller 120 may control to display the second identification information with respect to some display devices, e.g., display devices having the same device name, or to display the second identification information with respect to all of the display devices included in the searched display apparatus 200.

Further, the control signal for displaying the identification information may be transmitted to the display apparatus 200 through the server 400. Accordingly, the second identification information may be displayed on the display apparatus 200 in addition to the user device 100. The second identification information may be simultaneously displayed on the user device 100 and the display apparatus 200.

The terminal controller 120 may be one of various types of processors including at least one chip in which an integrated circuit is provided. The terminal controller 120 may be provided with one processor or a plurality of separate processors.

The terminal storage 150 temporarily or permanently stores data and a program for operating the user device 100. For example, the terminal storage 150 may store the transmitted device name and first identification information of the display apparatus 200. The terminal storage 150 may store the generated second identification information. In this case, the second identification information is stored according to the first identification information of the display apparatus 200. When the user device 100 transmits content, the terminal storage 150 temporarily or permanently stores the content. The terminal storage 150 may store a program for generating second identification information, and a program for displaying the second identification information.

The terminal storage 150 may include at least one type of storage media such as a flash memory type, a hard disk type, a multimedia card micro type, a card type memory (e.g., an SD memory, an XD memory, etc.), a RAM, an SRAM, a ROM, an EEPROM, a PROM, a magnetic memory, a magnetic disk, an optical disk, etc. The terminal storage 150 is not limited to the above, and may be implemented as an arbitrarily different form well-known in the art. Further, the user device 100 may manage a web storage which performs a storage function on the Internet.

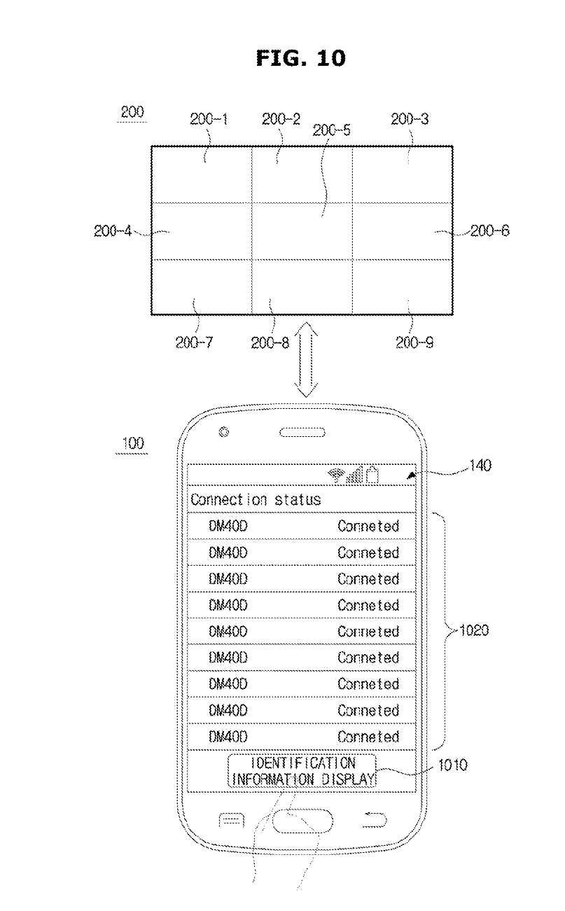

FIG. 10 is a view for describing a search list of a display apparatus searched through a user device according to an exemplary embodiment.

As shown in an upper view included in FIG. 10, a plurality of display devices 200-1 to 200-9 may be provided within a predetermined distance from a user device 100. The plurality of display devices 200-1 to 200-9 may have the same size and shape, and a screen may be provided in a generally quadrilateral shape by arranging the plurality of display devices 200-1 to 200-9.

In FIG. 10, it is assumed that the plurality of display devices 200-1 to 200-9 have the same device name, e.g., DM40D.

A user may input a search command to search a display apparatus 200 that is located close to the user through the terminal input device 130. The terminal communicator 110 searches the display apparatus 200 located within a predetermined distance, and receives a device name and first identification information e.g., a MAC address of the searched display apparatus 200. That is, the terminal communicator 110 receives device names and the first identification information of each of the plurality of display devices 200-1 to 200-9, and here, the device names of the plurality of display devices 200-1 to 200-9 are the same as DM40D, but the first identification information thereof may be different from each other.

The terminal display 140 displays a search list 1020, i.e., the list of the searched display apparatus 200. Here, the device names of the plurality of display devices 200-1 to 200-9 included in the display apparatus 200 may be displayed in the search list 1020. The terminal display 140 may sequentially display the device names of the plurality of display devices 200-1 to 200-9 included in the searched display apparatus 200 according to a searched order. Since the device names of the plurality of display devices 200-1 to 200-9 are the same as DM40D, the terminal display 140 repeatedly displays the device name of DM40D for each of the display devices 200-1 to 200-9 as shown in a lower view included in FIG. 10.

As described above, when the same device names are repeatedly displayed or when the same device names are included in the search list 1020, identification of the display devices included in the display apparatus 200 may not easy, and thus, the selection and operation of a display device included in the display apparatus 200 may be difficult. Accordingly, the terminal display 140 may display the device names together with second identification information of the display devices included in the display apparatus 200.

The second identification information may be displayed according to setting by a user. For example, the terminal display 140 may display a search list 1020 together with an icon 1010 “identification information display” in the lower portion of the search list 1020, and the user may select the icon 1010 using a push or touch method to set whether second identification information is displayed. When a screen is shifted to a set screen, the user may select a menu item to display the second identification information, and thus, the second identification information may be displayed in the search list 1020.

The icon 1010 “identification information display” may be separately displayed before the search list 1020 is displayed, which is different from the exemplary embodiment as shown in FIG. 10. When a screen is shifted to a set screen according to selection of the icon 1020 “identification information display”, the user may select a menu item to display the second identification information. The second identification information is generated according to selection by the user, and the generated second identification information may be displayed in the search list 1020.

The second identification information may be automatically displayed without setting by the user. For example, when the same device names are repeatedly displayed in the search list 1020, i.e., the display devices having the same device names exist in the search list 1020, the terminal display 140 may shift the screen having the same device names to a screen for displaying the second identification information.

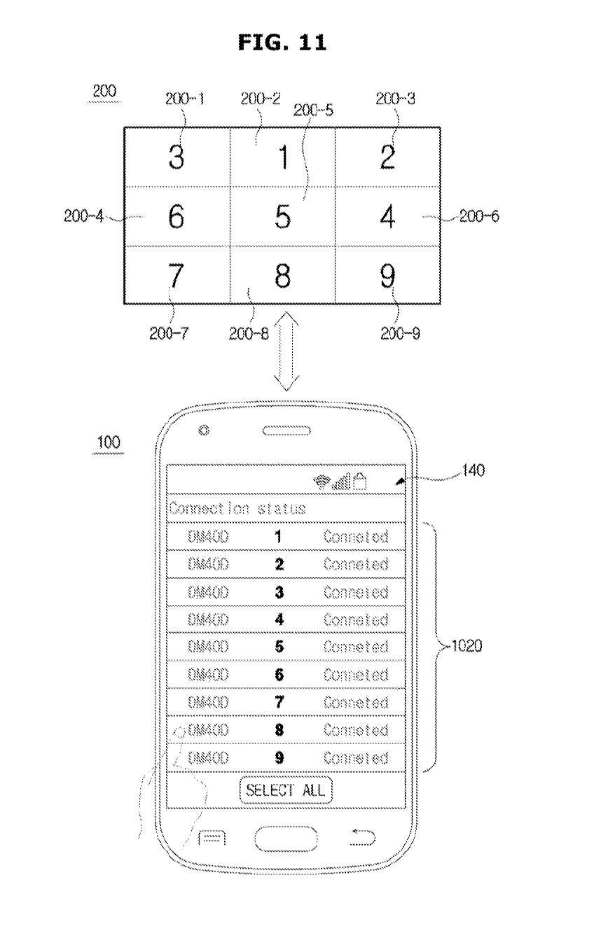

FIG. 11 is a view illustrating an example of displaying second identification information. It is assumed that a display apparatus 200 shown in an upper view of FIG. 11 is the same as that described in FIG. 10.

The terminal controller 120 generates second identification information corresponding to first identification information of the display apparatus 200. Since all device names of the plurality of display devices 200-1 to 200-9 are the same, the terminal controller 120 generates second identification information with respect to all of the plurality of display devices 200-1 to 200-9.

The terminal controller 120 may generate second identification information provided in a numeral format. The terminal controller 120 may generate the second identification information as numerical values of “1, 2, 3, 4, 5, 6, 7, 8, and 9” according to the number of display devices. The terminal controller 120 may sequentially generate the second identification information according to a searched order. The terminal controller 120 may generate a control signal to display the generated second identification information.

The terminal display 140 displays the second identification information according to the control signal of the terminal controller 120. As shown in a lower view included in FIG. 11, the terminal display 140 may display the device names together with the second identification information provided in a numeral format.

The second identification information generated from the terminal controller 120 is transmitted to the display apparatus 200. The second identification information is transmitted to each of the plurality of display devices 200-1 to 200-9. Since the second identification information thereof is generated to be different from each other based on the first identification information, the second identification information transmitted to each of the plurality of display devices 200-1 to 200-9 is different from each other according to the first identification information.

The display apparatus 200 displays the received second identification information. Each of the plurality of display devices 200-1 to 200-9 displays the second identification information generated and transmitted based on the first identification information. For example, since second identification information of “1” is generated with respect to a first searched display device in a search list 1020 of FIG. 11, a corresponding display device, i.e., the display device 200-2, receives and displays the second identification information of “1.” Further, since second identification information of “2” is generated with respect to a display device which is second searched, a corresponding display device, i.e., the display device 200-3, receives and displays the second identification information of “2.”

The second identification information may be simultaneously displayed on the user device 100 and the display apparatus 200. Accordingly, a user may identify the display devices using the second identification information displayed on the user device 100 and the display apparatus 200. As the second identification information provided in a simple format is displayed instead of displaying the first identification information of the display apparatus 200, the user may intuitively identify the display devices.

As described above, since the user may identify the display devices 200-1 to 200-9 included in the display apparatus 200, a display device to be operated among the plurality of display devices 200-1 to 200-9 may be selected.

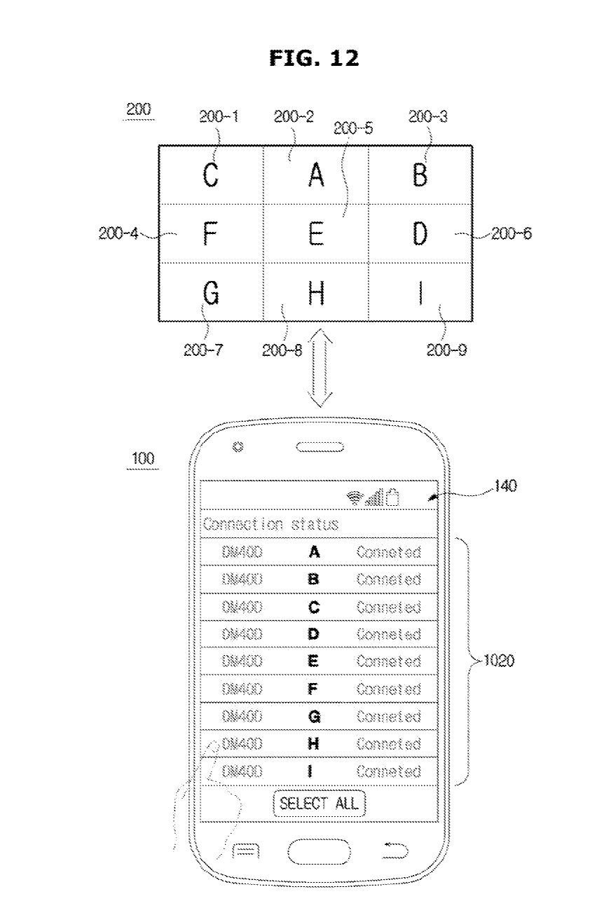

FIG. 12 is a view illustrating another example of displaying second identification information. It is assumed that display devices 200-1 to 200-9 of a display apparatus 200 shown in an upper view of FIG. 12 is the same as that described in FIG. 10. When descriptions are made with reference to FIG. 12, repetitive description of the same or corresponding elements of FIG. 11 is omitted.

The terminal controller 120 may generate second identification information provided in a character format based on first identification information of the display apparatus 200. The terminal controller 120 may generate second identification information as characters of “A, B, C, D, E, F, G, H, and I” according to the number of display devices included in the display apparatus 200. Further, the terminal controller 120 may sequentially generate the second identification information according to a searched order.

The terminal display 140 displays the second identification information according to a control signal of the terminal controller 120. As shown in a lower view included in FIG. 12, the terminal display 140 may display device names together with the second identification information provided in a character format.

The generated second identification information is transmitted to each of a plurality of display devices 200-1 to 200-9 based on the first identification information. Each of the plurality of display devices 200-1 to 200-9 displays the second identification information generated and transmitted based on the first identification information. For example, since second identification information of “A” is generated with respect to a first searched display device in a search list 1020 of FIG. 12, a corresponding display device, i.e., the display device 200-2, receives and displays the second identification information of “A.” Further, since second identification information of “B” is generated with respect to a second searched display device, a corresponding display device, i.e., the display device 200-3, receives and displays the second identification information of “B.”

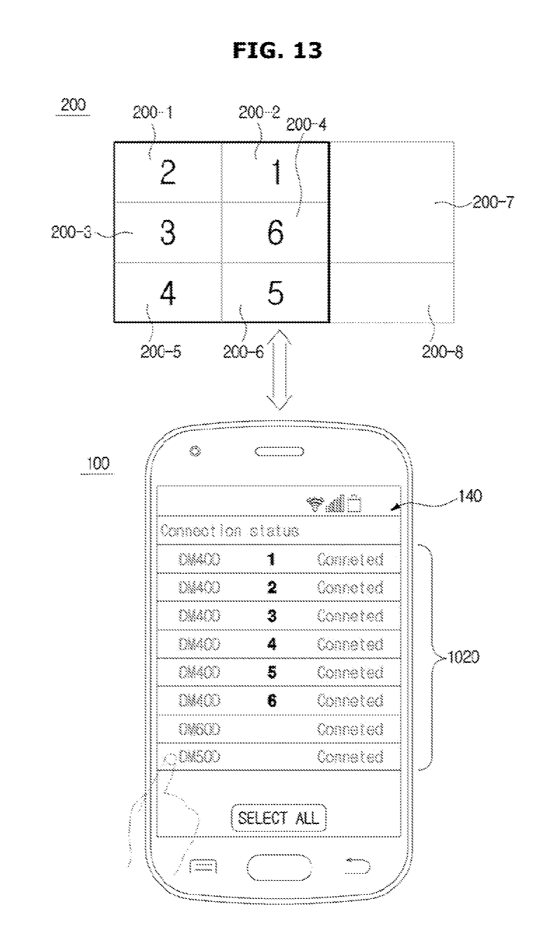

FIG. 13 is a view illustrating still another example of displaying second identification information.

As shown in an upper view included in FIG. 13, a plurality of display devices 200-1, 200-2, 200-3, 200-4, 200-5, 200-6, 200-7, and 200-8 may be provided within a predetermined distance from the user device 100. It is assumed that display devices 200-1 to 200-6 among the plurality of display devices 200-1, 200-2, 200-3, 200-4, 200-5, 200-6, 200-7, and 200-8 have the same size, shape, and device name, e.g., DM40D. On the other hand, the display devices 200-7 and 200-8 have different sizes or shapes, and thus have different device names from the display devices 200-1 to 200-6. Here, for example, a device name of the display device is DM60D, and a device name of the display device 200-8 is DM50D.

The terminal controller 120 may generate second identification information with respect to the display devices 200-1 to 200-6 having the same device name. The terminal controller 120 may generate the second identification information provided in a numeral format based on first identification information of the display devices 200-1 to 200-6. The terminal controller 120 may generate the second identification information as numerical values “1, 2, 3, 4, 5, and 6” according to the number of the display devices having the same device name, and may sequentially generate the second identification information according to a searched order.

The terminal display 140 displays the second identification information according to a control signal of the terminal controller 120. As shown in a lower view included in FIG. 13, the terminal display 140 may display the device names together with the second identification information provided in a numeral format.

The second identification information generated from the terminal controller 120 is transmitted to the display devices 200-1 to 200-6. Since the second identification information is differently generated from each other based on the first identification information, the second identification information transmitted to the display devices 200-1 to 200-6 is different from each other according to the first identification information.

The second identification information generated and transmitted based on the first identification information is displayed through each of the display devices 200-1 to 200-6. For example, since second identification information of “1” is generated with respect to a first searched display device among the display devices 200-1, 200-2, 200-3, 200-4, 200-5, and 200-6 having the same device name, a corresponding display device, i.e., the display device 200-2, receives and displays the second identification information of “1.” Further, since second identification information of “2” is generated with respect to a second searched display device, a corresponding display device, i.e., the display device 200-1, receives and displays the second identification information of “1.”

The second identification information may be simultaneously displayed on the user device 100 and the display apparatus 200. The user may visually and intuitively identify the display devices included in the display apparatus 200 and having the same device name using the second identification information displayed on the user device 100 and the display apparatus 200.

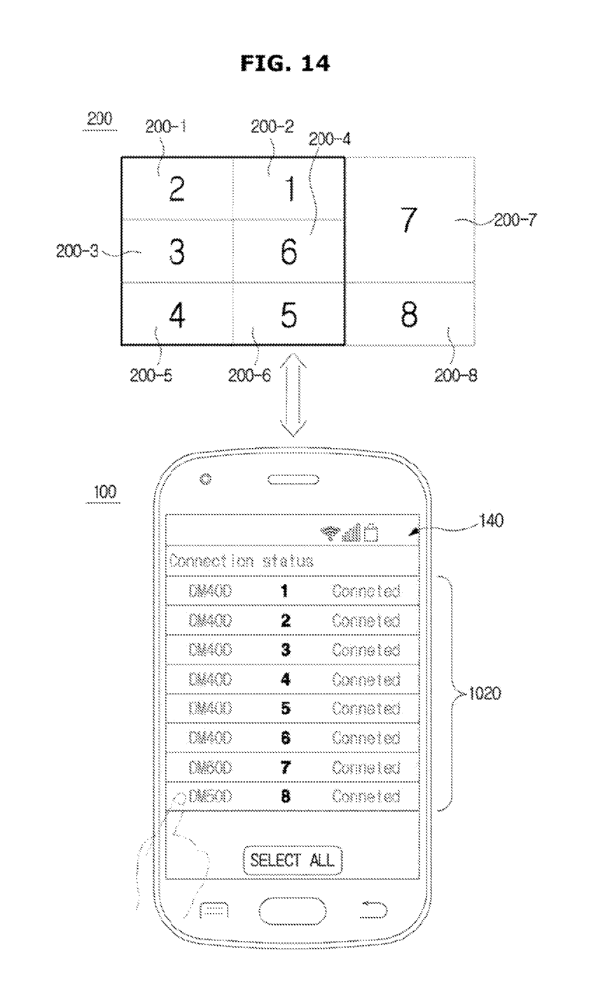

FIG. 14 is a view illustrating yet another example of displaying second identification information. It is assumed that a display apparatus 200 shown in an upper view of FIG. 14 is the same as that described with reference to FIG. 13, and repetitive description is omitted.

The terminal controller 120 may generate second identification information with respect to all of a plurality of display devices 200-1, 200-2, 200-3, 200-4, 200-5, 200-6, 200-7, and 200-8. The terminal controller 120 may generate the second identification information with respect to the display devices 200-7 and 200-8 having different device names in addition to the display devices 200-1 to 200-6 having the same device name. The terminal controller 120 may generate second identification information provided in a numeral format, i.e., “1, 2, 3, 4, 5, 6, 7, and 8” based on first identification information of the display apparatus 200. The terminal controller 120 may sequentially generate the second identification information according to a searched order.

The terminal display 140 displays the second identification information according to a control signal of the terminal controller 120. As shown in a lower view included in FIG. 14, the terminal display 140 may display the device names together with the second identification information provided in a numeral format.

The generated second identification information is transmitted to each of the plurality of display devices 200-1 to 200-8 based on the first identification information. Each of the plurality of display devices 200-1 to 200-8 displays the second identification information generated and transmitted based on the first identification information. For example, since second identification information of “4” is generated with respect to a fourth searched display device in a search list 1020 of FIG. 14, a corresponding display device, i.e., the display device 200-5, receives and displays the second identification information of “4.” Further, since second identification information of “7” is generated with respect to a seventh searched display device, a corresponding display device, i.e., the display device 200-7, receives and displays the second identification information of “7.”

The user may visually and intuitively identify all of the display devices displayed in the search list 1020 using the second identification information displayed on the user device 100 and the display apparatus 200.

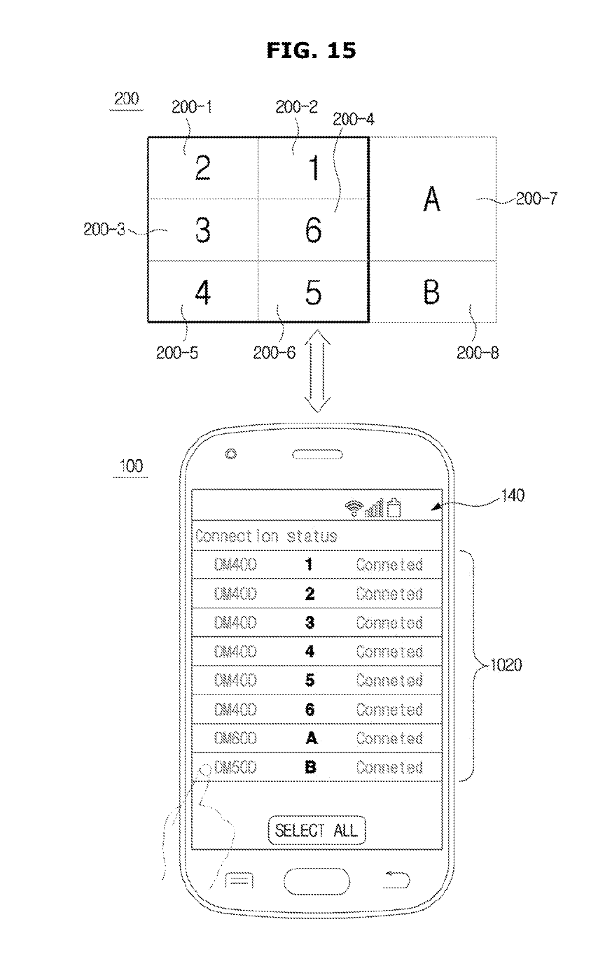

FIG. 15 is a view illustrating yet another example of displaying second identification information. It is assumed that a display apparatus 200 shown in an upper view of FIG. 15 is the same as that described with reference to FIG. 13, and repetitive description is omitted.

The terminal controller 120 may generate second identification information with respect to all of a plurality of display devices 200-1, 200-2, 200-3, 200-4, 200-5, 200-6, 200-7, and 200-8. The terminal controller 120 may generate second identification information as a mixed format. The terminal controller 120 generates second identification information provided in a numeral format, i.e., “1, 2, 3, 4, 5, and 6” with respect to the display devices 200-1 to 200-6 having the same device name, and may generate second identification information provided in a character format, i.e., “A and B” with respect to the display devices 200-7 and 200-8 having different device names.

As shown in a lower view included in FIG. 15, the generated second identification information and the device names are displayed in a search list 1020 of the user device 100. Further, the generated second identification information is transmitted to each of the plurality of display devices 200-1 to 200-8. Each of the second identification information generated and transmitted based on the first identification information is displayed through the plurality of display devices 200-1 to 200-8. For example, since second identification information of “4” is generated with respect to a fourth searched display device in the search list 1020 of FIG. 14, a corresponding display device, i.e., the display device 200-5, receives and displays the second identification information of “4.” Further, since second identification information of “A” is generated with respect to a seventh searched display device, a corresponding display device, i.e., the display device 200-7, receives and displays the second identification information of “A.”

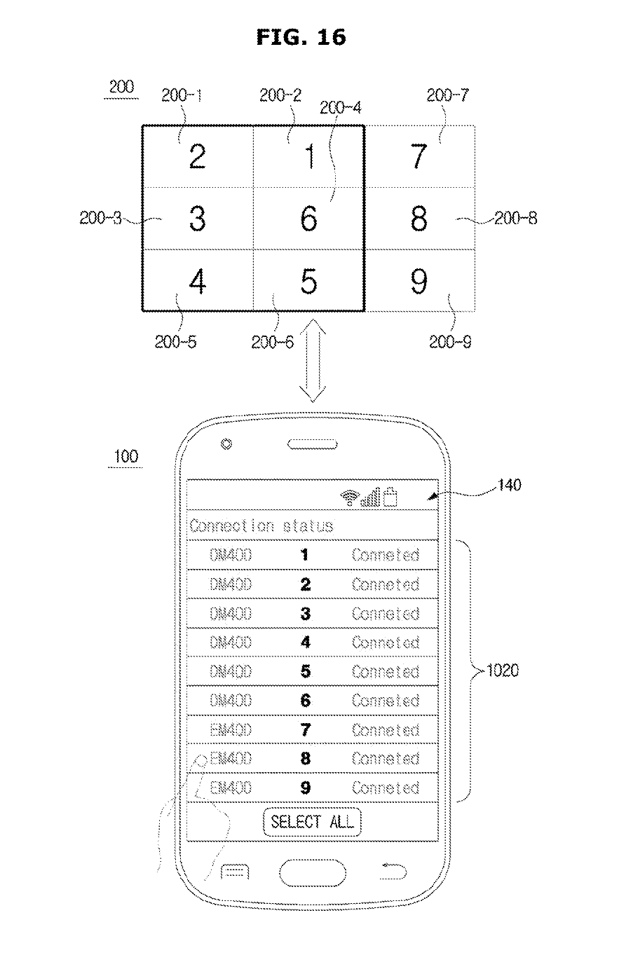

FIG. 16 is a view illustrating yet another example of displaying second identification information.

As shown in an upper view included in FIG. 16, a plurality of display devices 200-1, 200-2, 200-3, 200-4, 200-5, 200-6, 200-7, 200-8, and 200-9 may be provided within a predetermined distance from the user device 100. The plurality of display devices 200-1 to 200-9 may have the same size and shape. However, it is assumed that the display devices 200-1 to 200-6 among the plurality of display devices 200-1 to 200-9 have different device names from the display devices 200-7 to 200-9. Here, for example, the device names of the display devices 200-1 to 200-6 are DM40D, and the device names of the display devices 200-7 to 200-9 are EM40D.

In this case, the terminal controller 120 generates second identification information with respect to all of the plurality of display devices 200-1 to 200-9. The terminal controller 120 may generate the second identification information in the same format. The terminal controller 120 may sequentially generate the second identification information provided in a numeral format, i.e., “1, 2, 3, 4, 5, 6, 7, 8, and 9” according to a searched order.

The second identification information generated based on the first identification information is displayed together with the device names in a search list 1020 of the user device 100 as shown in a lower view included in FIG. 16. The second identification information is transmitted to the display apparatus 200 based on the first identification information, and displayed through each of the plurality of display devices 200-1 to 200-9.

For example, since second identification information of “4” is generated with respect to a fourth searched display device in the search list 1020 of FIG. 16, a corresponding display device, i.e., the display device 200-5, receives and displays the second identification information of “4.” Further, since second identification information of “7” is generated with respect to a seventh searched display device, a corresponding display device, i.e., the display device 200-7, receives and displays the second identification information of “7.”

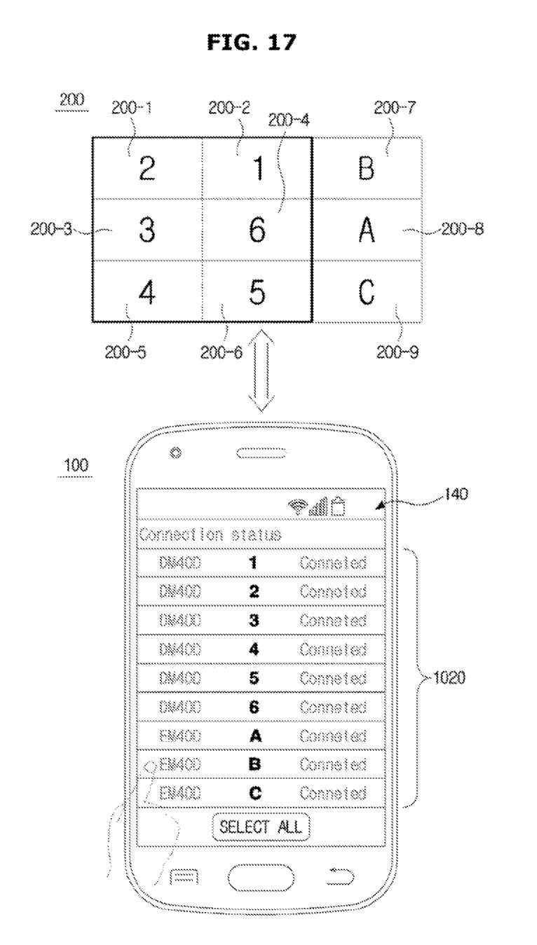

FIG. 17 is a view illustrating yet another example of displaying second identification information. It is assumed that a display apparatus 200 shown in an upper view of FIG. 17 is the same as that described with reference to FIG. 16, and repetitive description is omitted.

The terminal controller 120 generates second identification information with respect to all of a plurality of display devices 200-1, 200-2, 200-3, 200-4, 200-5, 200-6, 200-7, 200-8, and 200-9. The terminal controller 120 may generate the second identification information in a mixed format. For example, the terminal controller 120 generates second identification information provided in a numeral format, i.e., “1, 2, 3, 4, 5, and 6” with respect to the display devices 200-1 to 200-6 having a device name as DM40D, and may generate second identification information provided in a character format, i.e., “A, B, and C” with respect to the display devices 200-7 to 200-9 having a device name as EM40D.

As shown in a lower view included in FIG. 17, the generated second identification information is displayed together with the device names in a search list 1020 of the user device 100. Further, the generated second identification information is transmitted to each of the plurality of display devices 200-1 to 200-9. The second identification information generated and transmitted based on the first identification information is displayed through each of the plurality of display devices 200-1 to 200-9.

For example, since second identification information of “4” is generated with respect to a fourth searched display device in the search list 1020 of FIG. 17, a corresponding display device, i.e., the display device 200-5, receives and display the second identification information of “4.” Further, since second identification information of “A” is generated with respect to a seventh searched display device, a corresponding display device, i.e., the display device 200-8, receives and display the second identification information of “A.”

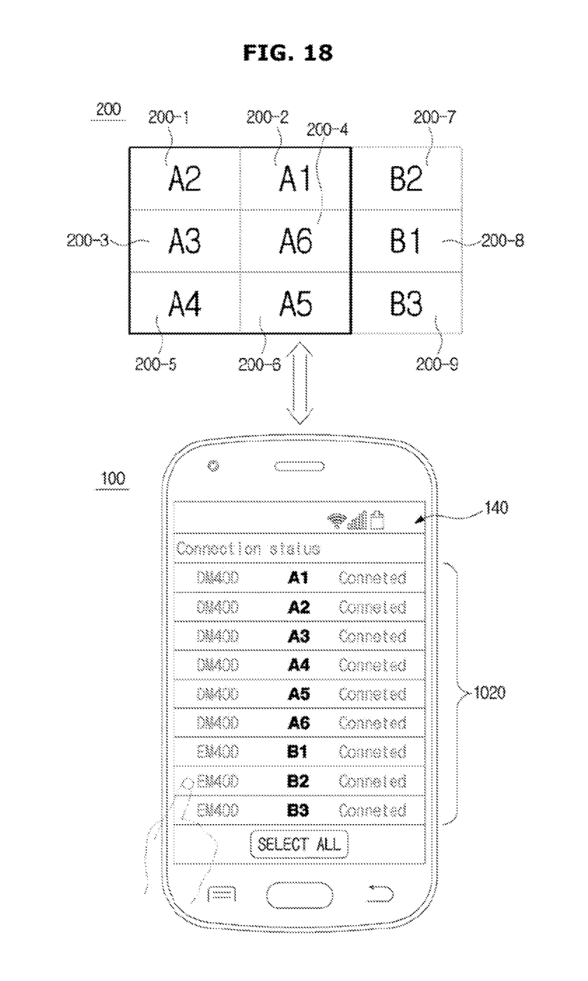

FIG. 18 is a view illustrating yet another example of displaying second identification information. It is assumed that a display apparatus 200 shown in an upper view of FIG. 18 is the same as that described with reference to FIG. 16.

The terminal controller 120 generates second identification information with respect to all of a plurality of display devices 200-1, 200-2, 200-3, 200-4, 200-5, 200-6, 200-7, 200-8, and 200-9. The terminal controller 120 may generate second identification information in a format in which numerals and characters are combined. The terminal controller 120 generates second identification information provided as “A1, A2, A3, A4, A5, and A6” with respect to the display devices 200-1 to 200-6 having a device name as DM40D, and may generate second identification information provided as “B1, B2, and B3” with respect to the display devices 200-7 to 200-9 having a device name as EM40D.

As shown in a lower view included in FIG. 18, the generated second identification information is displayed together with the device names in a search list 1020 of the user device 100. The second identification information generated and transmitted based on the first identification information is simultaneously displayed on the user device 100 and each of the plurality of display devices 200-1 to 200-9.

For example, since second identification information of “A4” is generated with respect to a fourth searched display device in the search list 1020 of FIG. 18, a corresponding display device, i.e., the display device 200-5, receives and displays the second identification information of “A4.” Further, since second identification information of “B1” is generated with respect to a seventh searched display device, a corresponding display device, i.e., the display device 200-8, receives and displays the second identification information of “B1”.

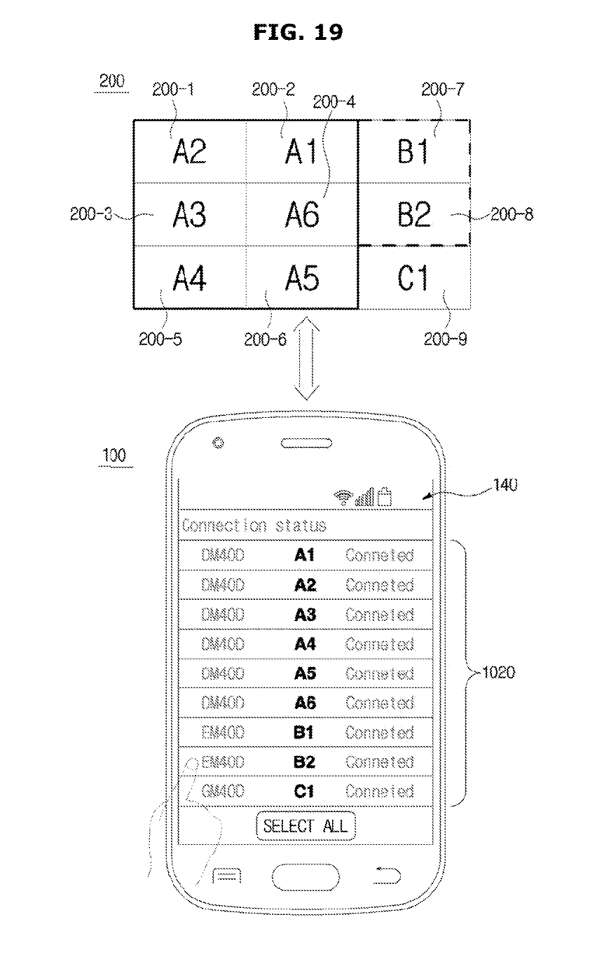

FIG. 19 is a view illustrating yet another example of displaying second identification information.

As shown in an upper view included in FIG. 19, a plurality of display devices 200-1, 200-2, 200-3, 200-4, 200-5, 200-6, 200-7, 200-8, and 200-9 may be provided within a predetermined distance from the user device 100, and the plurality of display devices 200-1 to 200-9 may have the same size and shape. However, the device names of the display devices 200-1 to 200-6, the device names of the display devices 200-7 and 200-8, the device name of the display device 200-9 among the plurality of display devices 200-1 to 200-9 may be different from each other. Here, for example, the device names of the display devices 200-1 to 200-6 may be DM40D, the device names of the display devices 200-7 and 200-8 may be EM40D, and the device name of the display device 200-9 may be GM40D.

The terminal controller 120 may generate second identification information as “A1, A2, A3, A4, A5, and A6” with respect to the display devices 200-1 to 200-6 having a device name as DM40D, second identification information as “B1 and B2” with respect to the display devices 200-7 and 200-8 having a device name as EM40D, and second identification information as “C1” with respect to the display device 200-9 having a device name as GM40D.

The second identification information generated based on the first identification information is displayed together with the device names in a search list 1020 of the user device 100 as shown in a lower view included in FIG. 19. Further, the second identification information is transmitted to and displayed on each of the plurality of display devices 200-1 to 200-9 based on the first identification information.

For example, second identification information of “A4” is generated with respect to a fourth searched display device in the search list 1020 of FIG. 19, a corresponding display device, i.e., the display device 200-5, receives and displays the second identification information of “A4.” Further, second identification information of “B1” is generated with respect to a seventh searched display device, a corresponding display device, i.e., the display device 200-7, receives and displays the second identification information of “B1.” Further, second identification information of “C1” is generated with respect to a ninth searched display device, a corresponding display device, i.e., the display device 200-9, receives and displays the second identification information of “C1.”

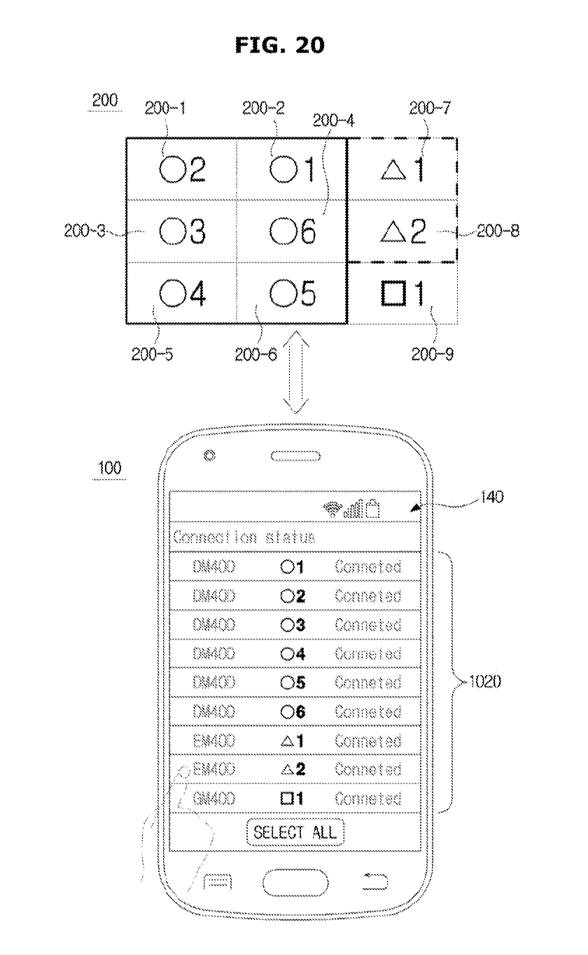

FIG. 20 is a view illustrating yet another example of displaying second identification information. It is assumed that a display apparatus 200 shown in an upper view of FIG. 20 is the same as that described with reference to FIG. 19.

Referring to FIG. 20, the terminal controller 120 may generate second identification information including figures, and may generate second identification information in a format in which a numeral and a figure are combined. The terminal controller 120 may generate second identification information as “O1, O2, O3, O4, O5, and O6” with respect to the display devices 200-1 to 200-6 having a device name as DM40D, may generate second identification information as “Δ1 and Δ2” with respect to the display devices 200-7 and 200-8 having a device name as EM40D, and may generate second identification information as “□1” with respect to the display device 200-9 having a device name as GM40D.

The second identification information generated based on the first identification information is displayed on the user device 100. Simultaneously, the second identification information is transmitted to and displayed on each of the plurality of display devices 200-1, 200-2, 200-3, 200-4, 200-5, 200-6, 200-7, 200-8, and 200-9 based on the first identification information. Accordingly, as shown in FIG. 20, second identification information of “O4” is generated with respect to a fourth searched display device in a search list 1020, and a corresponding display device, i.e., the display device 200-5, receives and transmits the second identification information of “O4.” Second identification information of “Δ1” is generated with respect to a seventh searched display device, and a corresponding display device, i.e., the display device 200-7, receives and displays the second identification information of “Δ1.” Further, second identification information of “□1” is generated with respect to a ninth searched display device, and a corresponding display device, i.e., the display device 200-9, receives and displays the second identification information of “□1.”

Accordingly, since the second identification information is displayed on the user device 100 and the display apparatus 200, a user may visually and intuitively identify the display devices shown in the search list 1020, and easily select a display device to be operated.

As described above, examples for displaying the second identification information by the display apparatus control system 1 have been described with reference to FIG. 10 to FIG. 20, but are not limited thereto, and any types of displays may be adopted without a limitation as long as the display devices included in the display apparatus 200 may be intuitively and visually identified.

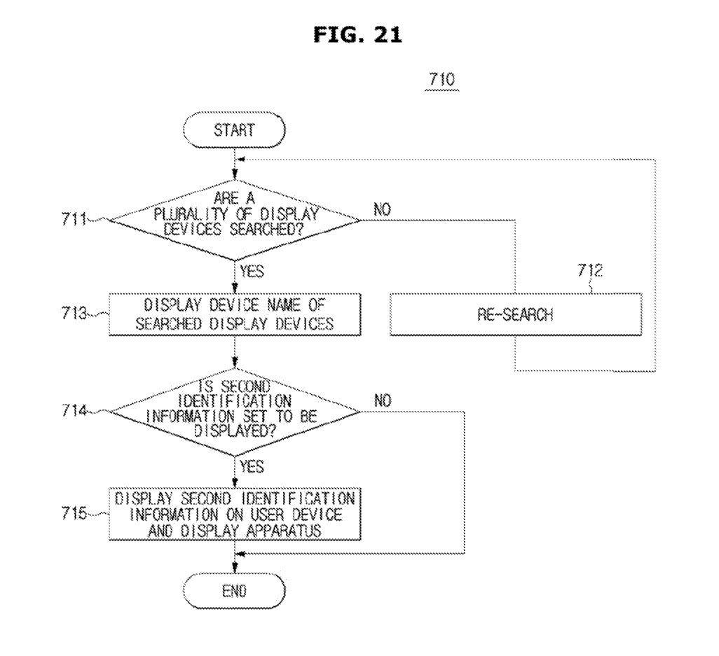

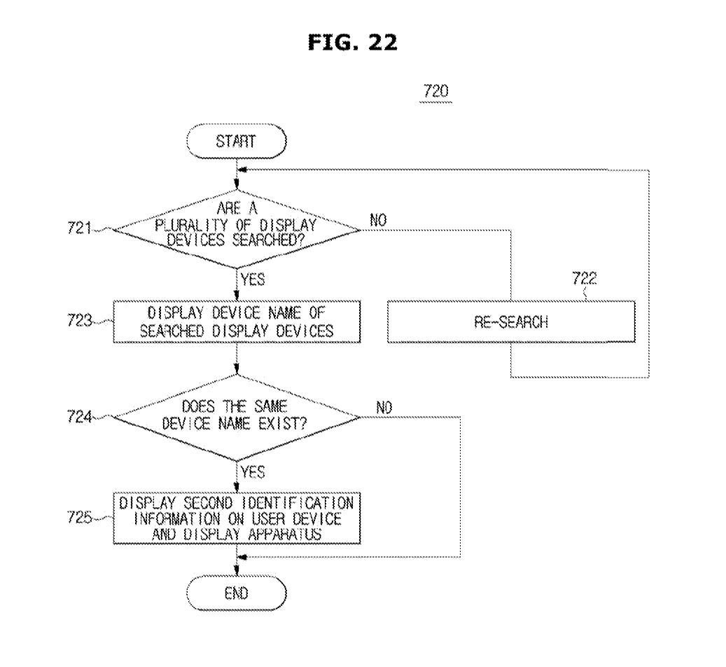

Hereinafter, a display apparatus control method will be described with reference to FIGS. 21 and 22.

FIG. 21 is a flowchart illustrating a display apparatus control method according to an exemplary embodiment.

Referring to FIG. 21, the user device 100 searches for the display apparatus 200 located within a predetermined distance from the user device 100 and determines whether the plurality of display devices included in the display apparatus 200 are searched (S711).

When the searched display apparatus is or only one display device of the display apparatus is searched, the user device 100 performs re-searching of the display apparatus 200 (S712). The re-searching may be immediately performed, or may be performed after a predetermined time elapses.

When a plurality of display devices are searched, the user device 100 displays a search list of the searched display apparatus 200 (S713). Here, device names of the display devices may be included in the search list. For example, the user device 100 displays the device names of the searched display devices in a list form.

Subsequently, the user device 100 determines whether second identification information is set to be displayed (S714).

A user may select a menu item for displaying the second identification information from a set screen of the user device 100, and the user device 100 determines whether the menu item is selected, before or after the second identification information is generated.

When the second identification information is not set to be displayed, i.e., the menu item for displaying the second identification information is not selected, the search is completed.

On the other hand, when the second identification information is set to be displayed, i.e., the menu item is selected, the user device 100 and the display apparatus 200 display the second identification information (S715).

The user device 100 generates the second identification information based on the first identification information of the display apparatus 200, and displays the generated second identification information together with the device names on the search list. The user device 100 transmits the generated second identification information to the display apparatus 200 according to the first identification information, and the display apparatus 200 displays the received second identification information.

The second identification information may be simultaneously displayed on the user device 100 and the display apparatus 200. Accordingly, the user may identify the plurality of display devices using the second identification information displayed on the user device 100 and the display apparatus 200.

The user device 100 and the display apparatus 200 may display the second identification information provided in a simple format instead of directly displaying the first identification information, and thus, the user can intuitively identify the display devices included in the display apparatus 200. Further, since the user may identify the display devices, a display device to be operated can be easily selected.

FIG. 22 is a flowchart illustrating a display apparatus control method according to another exemplary embodiment.

Referring to FIG. 22, first, the user device 100 searches the display apparatus 200 located within a predetermined distance from the user device 100 and determines whether the plurality of display devices are searched (S721).

When the searched display apparatus is not present or only one display device of the display apparatus is searched, the user device 100 performs re-searching of the display apparatus 200 (S722).

When a plurality of display devices are searched, the user device 100 displays device names of the searched display devices in a list form (S723).

Subsequently, the user device 100 determines whether the same device name for at least two display devices exist in the search list, or whether the same device name is duplicated and displayed on the search list (S724).

When the same device names do not exist, the search is completed.

When the same device names exist, the user device 100 and the display apparatus 200 display the second identification information (S725).

According to exemplary embodiments, the user device 100 generates the second identification information based on the first identification information of the display apparatus 200, and the generated second identification information is displayed together with the device names on the search list. The user device 100 transmits the generated second identification information to the display apparatus 200 according to the first identification information, the display apparatus 200 displays the received second identification information. As described above, the second identification information may be simultaneously displayed on the user device 100 and the display apparatus 200.

As is apparent from the above description, according to the display apparatus and the user apparatus, the display apparatus control system, and the method for controlling the display apparatus, a plurality of display devices can be intuitively identified. Accordingly, the identification can provide convenience to select a desired display device from the plurality of display devices, or to connect to or control the desired display device. Furthermore, the inconvenience of processing and controlling the plurality of display devices to display content thereon can be reduced.

The method for controlling the display apparatus according to the exemplary embodiments may be recorded as programs that can be executed on a computer and implemented through general-purpose digital computers which can run the programs using a computer-readable recording medium. Data structures described in the above methods can also be recorded on a computer-readable recording medium in various manners. Examples of the computer-readable recording medium include storage media such as magnetic storage media (e.g., read-only memories (ROMs), floppy disks, hard disks, etc.) and optical recording media (e.g., CD-ROMs or DVDs). Furthermore, the computer-readable recording media may include computer storage media and communication media. The computer storage media may include both volatile and nonvolatile and both detachable and non-detachable media implemented by any method or technique for storing information such as computer-readable instructions, data structures, program modules or other data. The communication media may store computer-readable instructions, data structures, program modules, other data of a modulated data signal such as a carrier wave, or other transmission mechanism, and may include any information transmission media.

Although a few embodiments have been shown and described, it would be appreciated by those skilled in the art that changes may be made in the exemplary embodiments without departing from the principles and spirit of the disclosure, the scope of which is defined in the claims and their equivalents.

What is claimed is:

1. A display apparatus control system comprising:
a plurality of display devices; and
a user apparatus configured to generate second identification information based on first identification information of the plurality of display devices, and display the second identification information on a display of the user apparatus,
wherein at least one of the plurality of display devices is configured to display the second identification information.

2. The system according to claim 1, wherein the plurality of display devices are determined to be located within a predetermined distance from the user apparatus.

3. The system according to claim 1, wherein the first identification information comprises at least one of an Internet protocol (IP) address, a media access control (MAC) address, and global positioning system (GPS) information.

4. The system according to claim 1, wherein the second identification information comprises at least one of a numeral, a character, and a figure.

5. The system according to claim 1, wherein the plurality of display devices are configured to display the second identification information substantially simultaneously with a display of the second identification information on the display of the user apparatus.

6. The system according to claim 1, wherein the user apparatus is configured to search the plurality of display devices, and display a search list with respect to the plurality of display devices based on a search result.

7. The system according to claim 6, wherein the search list comprises device names of the plurality of display devices.

8. The system according to claim 7, wherein the user apparatus is configured to generate the second identification information with respect to display devices having the same device name among the plurality of display devices.

9. The system according to claim 7, wherein the user apparatus is configured to display, on the display of the user apparatus, the same device names of the display devices together with the second identification information.

10. The system according to claim 7, wherein the user apparatus is configured to generate the second identification information and, in response to setting, configured to display the second identification information on the display of the user apparatus.

11. The system according to claim 7, wherein the user apparatus is configured to generate the second identification information and, in response to a presence of display devices having the same device name among the plurality of display devices, configured to display the second identification information on the display of the user apparatus.

12. A user apparatus for controlling a plurality of display devices, the user apparatus comprising:
a terminal display; and
a terminal controller configured to generate second identification information based on first identification information of the plurality of display devices,
wherein the terminal controller is configured to control the terminal display to display the second identification information.

13. The user apparatus according to claim 12, wherein the plurality of display devices are determined to be located within a predetermined distance from the user apparatus.

14. The user apparatus according to claim 12, wherein the first identification information comprises at least one of an IP address, a MAC address, and GPS information.

15. The user apparatus according to claim 12, wherein the second identification information comprises at least one of a numeral, a character and a figure.

16. The user apparatus according to claim 12, wherein the terminal controller is configured to control the terminal display to display a search list with respect to the plurality of display devices based on a search result.

17. The user apparatus according to claim 16, wherein the search list comprises device names of the plurality of display devices.

18. The user apparatus according to claim 17, wherein the terminal controller is configured to generate the second identification information with respect to display devices having the same device name among the plurality of display devices.

19. The user apparatus according to claim 17, wherein the terminal controller is configured to control the terminal display to display the device names together with the second identification information.

20. The user apparatus according to claim 17, wherein the terminal controller is configured to generate the second identification information and, in response to setting, configured to control the terminal display to display the second identification information.

21. The user apparatus according to claim 17, wherein the terminal controller is configured to control the terminal to display the second identification information in response to setting.

22. The user apparatus according to claim 17, wherein the terminal controller is configured to generate the second identification information in response to a presence of display devices having the same device name among the plurality of display devices.

23. The user apparatus according to claim 17, wherein the terminal controller is configured to control the terminal display to display the second identification information in response to a presence of display devices having the same device name among the plurality of display devices.

24. A display apparatus controlled by a user apparatus, the display apparatus comprising:
a storage configured to store first identification information of the display apparatus;
a communicator configured to receive second identification information, the second identification being generated by the user apparatus based on the first identification information; and
a display configured to display the second identification information.

25. The display apparatus according to claim 24, wherein the display apparatus is determined to be located within a predetermined distance from the user apparatus.

26. The display apparatus according to claim 24, wherein the first identification information comprises at least one of an IP address, a MAC address, and GPS information.

27. The display apparatus according to claim 24, wherein the second identification information comprises at least one of a numeral, a character, and a figure.

28. The display apparatus according to claim 24, wherein the display is configured to display the second identification information substantially simultaneously with a display of the second identification information on a display of the user apparatus.

29. A method of controlling a display apparatus, the method comprising:
generating, by a user apparatus, second identification information based on first identification information of a plurality of display devices, the user apparatus controlling the plurality of display devices;
displaying the second identification information on a display of the user apparatus;
transmitting the second identification information to the plurality of display devices from the user apparatus; and
displaying the second identification information on at least one of the plurality of display devices.
